(19) United States
(12) Patent Application Publication
(10) Pub. No.: US 2007/0118243 A1
(43) Pub. Date: May 24, 2007

(54) PERSONAL FIT MEDICAL IMPLANTS AND ORTHOPEDIC SURGICAL INSTRUMENTS AND METHODS FOR MAKING

(75) Inventors: James Schroeder, Waukesha, WI (US); Steven L. Goodman, Madison, WI (US); Kyu-Jung Kim, Walnut, CA (US)

Correspondence Address: GODFREY & KAHN S.C., 780 NORTH WATER STREET, MILWAUKEE, WI, 53202, US

(73) Assignee: VANTUS TECHNOLOGY CORPORATION

(21) Appl. No.: 11/549,928

(22) Filed: Oct. 16, 2006

Related U.S. Application Data
(60) Provisional application No. 60/596,704, filed on Oct. 14, 2005.

(51) Int. Cl. G06F 19/00

(52) U.S. Cl. 700/118; 623/901; 700/98

(57) ABSTRACT

The present invention provides methods, techniques, materials and devices and uses thereof for custom-fitting biocompatible implants, prosthetics and interventional tools for use on medical and veterinary applications. The devices produced according to the invention are created using additive manufacturing techniques based on a computer generated model such that every prosthesis or interventional device is personalized for the user having the appropriate metallic alloy composition and virtual validation of functional design for each use.

This utility patent application claims the benefit of and priority to U.S. Provisional Application 60/596,704 filed Oct. 14, 2005, incorporated herein by reference in its entirety.

### FIELD OF THE INVENTION

The present invention relates to methods, devices, and instruments to improve the quality of healthcare through the production of medical implants and surgical instruments that are fabricated to precisely fit individual users. This invention is implemented and based upon a combination of technologies including medical imaging, quantitative image analysis, computer aided design, computer aided manufacturing, and additive manufacturing processes that can directly produce high strength metallic and composite devices. Specifically, the present invention uses techniques of freeform manufacture to produce biocompatible articles that are personalized to the user.

### BACKGROUND OF THE INVENTION

Medical implants have dramatically improved the quality of life for many persons. Orthopedic implants such as total artificial hips, total artificial knees, fracture fixation plates, various fixtures, pins, wire, nails, intramedullary rods, and many others have enabled patients to return to a high level of functional restoration and a high level of quality of life following debilitating diseases such as osteoarthritis, osteosarcoma, and physical trauma. Current implants used for these and other skeletal corrections and repairs are produced in a variety of sizes to fit a broad range of patients and needs. Typically the medical professional will attempt to choose the appropriate size and shape of the prosthetic device prior to surgery, and will make a final determination during the surgical procedure. However, this protocol does not always meet with success. Often the surgeon must choose between one size that is too large and another that is too small, or another that is close but not quite the correct shape. In consideration of the infinite variation of patient anatomy combined with the infinite variation of disease and/or trauma, this means that ideally every required implant will be different. Although surgeons can often improvise the fit through selective removal of the patient's bone, removing otherwise healthy or undamaged tissue is not desirable, and the fit will in most cases still be less than optimal. In some cases it may be possible for the surgeon to modify the device to make a better fit, but it is not generally feasible to machine, bend, grind, drill or otherwise modify the structure of the very tough materials used in orthopedic devices within the constraints of the operating theater.

Newer methods using finite element analysis for use in rapid prototyping have been discussed, see for example, B. V. Mehta, Annals of Biomedical Engineering, Blackwell Science, Inc., Vol. 23, S.1, 1995, pp. 9. While such methods discuss three dimensional imaging of the implant site and design of implantable device they are limited to uses for rapid prototyping and do not allow for the production of an actual prosthesis or usable article.

For example, Johnson et al., U.S. Pat. No. 7,105,026, disclose a modular knee prosthesis. This prosthesis attempts to solve the problem of soft tissue balancing, which requires a surgical compromise to achieve a balance between flexion and extension gaps. Johnson et al. disclose a modular knee system having various distal posterior femoral components that are interchangeable so that the surgeon can choose the most correct compromise. Similarly, Sanford et al., U.S. Pat. No. 6,916,324, disclose a provisional orthopedic prosthesis for partially resected bone. Briefly, disclosed is a provisional orthopedic prosthesis having a first provisional component and a second optional component. The provisional component is used to assess the fit of a permanent prosthesis and is mounted on a partially prepared bone so as to allow a permanent prosthesis to be more accurately fitted. In both cases the final prostheses require an initial fitting or optimization of a generic prosthesis to achieve the fit of the permanent prosthesis. In such cases the need to fit the subject with the generic device or adapt the generic device could have been avoided if a personalized or custom fit prosthesis had been fabricated in the first place.

Similarly, medical instruments are produced and manufactured in a series of standard sizes so as to best approximate the need of the users. In such cases the length, size and grip of an instrument are generally not available in hybrid sizes, custom designs or custom alloy mixtures. In such cases, the physician or end-user is limited to the best fit, weight or alloy available. In these cases, it would be helpful for the practitioner if there were medical instruments available that were a precise fit for the size and grip of the user.

Accordingly, it would be desirable to have medical implants and instruments that are customized for the end-user to provide a customized fit. Furthermore, it is desirable to have implants for each patient that have different physiological and functional demands such as different biomechanical characteristics suitable for that individual patient. For example, it would be desirable to have implants that require a specific design in order to obtain an optimal function as well as an optimal fit for a patient with severe osteoporosis and/or significant variations in anatomic structures. Similarly, it would be beneficial to a surgeon or other health-care professional to have medical instruments that were custom-fit or personalized such that the size, weight, grip, cutting edge or alloy combination were optimized to the users requirements thereby alleviating or minimizing any fatigue or soreness that may result from a less than ideally designed instrument.

### SUMMARY OF THE INVENTION

Generally, the present invention provides methods, techniques, materials and devices and uses thereof for custom-fitting biocompatible implants, prosthetics and interventional tools for use on medical and veterinary applications. The devices produced according to the invention are created using additive manufacturing techniques based on a computer generated model such that every prosthesis or interventional device is personalized for the user having the appropriate metallic alloy composition and virtual validation of functional design for each use.

In one preferred embodiment, the present invention provides a method of custom-fitting a biocompatible device. This method comprises the steps of (a) receiving input imaging data from a patient; (b) calibrating, analyzing and constructing solid modeling from the input imaging data; and (c) manufacturing the biocompatible device from the three dimensional (3D) computer aided design (CAD) solid modeling. In this method, the device may be an implant, a prosthesis or an interventional tool.

In this method, preferably, the input imaging data is received from MRI, X-Ray, CT, ultrasound, LASER interferometry or PET scanning of the patient. This imaging data is then used to derive a 3D CAD solid model which is used for computer aided engineering (CAE) analyses such as finite element analysis (FEA), behavior modeling and functional component simulation. A 3D CAD solid model is used to derive an FEA model for modeling biological tissue for the target patient and for FEA of differing materials. The 3D CAD solid model is also used for computer aide manufacturing (CAM). A 3D CAD solid model provides excellent visualization for design validation and will be used as such.

In a preferred embodiment, the biocompatible device is manufactured by additive manufacturing process. In yet another embodiment, the device may be a skeletal orthopedic prosthesis or implant, a dental prosthesis, an implant, a soft tissue or hard tissue prosthesis or implant or a surgical tool or device.

In another embodiment, the biocompatible device is selected from a group consisting of long bones, plates, intramedullary rods, pins, total joint prosthesis or portions thereof, pelvic reconstruction prosthesis, cranial reconstruction prosthesis, maxillofacial reconstruction prosthesis, dental prosthesis, external fixation device for aligning long bones and the spine, sliding joints, overlapping plates, external or implantable orthopedic intervention prosthesis, adjustable fixtures, internal Ilizarov device for enabling the expansion or lengthening of long bones, implantable non-orthopedic prosthesis for cardiovascular, neurological, digestive or interventional implant device for soft or hard tissue repair, cardiovascular stents, urological stents, interventional tools, interventional guides to assist accurate preparation of the tissue to enable the proper fit of the device, and instruments for laparoscopic, interventional, radiological, and minimally invasive procedures for cardiovascular, neurological, digestive applications in soft or hard tissues.

In a preferred embodiment, the biocompatible device is manufactured from materials such as Cobalt-Chromium-Molybdenum alloy, Titanium alloy, commercially pure Ti (cpTi), medical grade stainless steel, Tantalum, Tantalum alloy, Nitinol, ceramics, oxides, minerals, glasses and combinations thereof. Preferably, these materials are selected based on desirability of biomechanical properties and interaction with surrounding biological environment of the device.

In another preferred embodiment, the device is manufactured using at least two materials which are fabricated sequentially, regionally, locally or in combinations thereof.

In another preferred embodiment, the device is a bone prosthesis and the fabrication materials are Ti6-4 in combination with cpTi. More preferably, the fabrication material is Nitinol (NiTi) alloy, such that the device surface is substantially made of Ti for minimizing Ni toxicity.

In certain embodiments, the biocompatible device is fabricated by additive manufacturing fabrication. During this fabrication, the device is further added with an element. Such elements may include a functional sensor, an optical element or a structural element. In another embodiment, such elements include a MEMS lens, optical lens, ceramic whisker or a curved external fixture for Ilizarov device.

In certain preferred embodiments, the biocompatible device has internal structure or surface which may include honeycombs, struts or ribs, or combinations thereof.

In certain other preferred embodiments, the biocompatible device may be a supporting fixture for neck or spine trauma. In certain embodiments, the method of custom-fitting a biocompatible device may be a custom cast or an articulation brace device having adjustability such that the range of articulation can be slowly expanded. In other embodiments, the biocompatible device is a surgical tool that fits to hand and motion mechanics.

In a most preferred embodiment, the invention provides a method of custom-fitting a biocompatible device, comprising the steps of: (a) quantitatively calibrating of medical imaging; (b) analyzing the calibrated medical image; (c) compiling computer aided design (CAD) of the analyzed and calibrated medical image; (d) creating computer aided manufacturing (CAM) for CAD of step (c); (e) performing finite element analysis of biological tissues of CAM from step (d); (f) performing finite element analysis of function of the design and fabrication; (g) performing solid modeling using 3D visualization instrumentation and virtual reality; and (h) manufacturing the device using additive manufacturing processes. In this embodiment, the additive manufacturing process used is preferably LASER Additive Manufacturing. However, in other preferred embodiments, the additive manufacturing process is Fused Deposition Modeling, Direct Metal Deposition, Laser Engineered Net Shaping, Selective Laser Sintering, Shape Deposition Manufacturing, Stereolithography, Electron-Beam Projection Lithography or Electron Beam Melting. Certain other embodiments are devices produced by processes described above.

In sum, the present invention represents methods, techniques, materials and devices and uses thereof for custom-fitting biocompatible implants, prosthetics and interventional tools for use on medical and veterinary applications. These and other objects and advantages of the present invention will become apparent from the detailed description accompanying the drawings.

### BRIEF DESCRIPTION OF THE FIGURES

Various exemplary embodiments of the methods of this invention will be described in detail, with reference to the following figures, wherein:

FIG. 1 illustrates a schematic of one preferred embodiment of the present invention depicting general methodology used for creating customized medical implants and prosthesis described in this invention;

FIGS. 2A and 2B illustrate a detailed schematic of one method according to one preferred embodiment as illustrated in FIG. 1;

FIGS. 3A, 3B, 3C and 3D illustrate another preferred embodiment of the present invention, wherein a series of three-dimensional images and image reconstruction are generated from MRI images in order to provide implant devices for reconstruction of cranial defects. FIG. 3A is an MRI image of an osteosarcoma patient; FIG. 3B is a transverse section through the prospective implant site; FIG. 3C is a close up saggital view of the implant site; and FIG. 3D is a front perspective view of the cranium;

FIGS. 4A-4D illustrate yet another preferred embodiment of the present invention for providing an adjustable plate prosthetic for surgical repair. FIG. 4A is an MRI image generated showing the site for a prospective prosthesis; FIG. 4B is a reverse MRI image showing the virtual fitting of the prosthesis in place; FIG. 4C shows the outline of the prospective prosthesis; and FIG. 4D represents the actual prosthesis in place;

FIG. 5 illustrates yet another preferred embodiment of the present invention for providing an adjustable plate prosthetic for surgical repair. In this embodiment, the plate has two similar anchor ends that are adjustably connected using a slidable and fixable bridge.

FIG. 6 illustrates another embodiment of the present invention wherein the invention provides an adjustable multiple plate prosthetic for surgical repair of the ilium.

FIG. 7 illustrates another embodiment of the present invention wherein the invention provides a complex stent with multiple segments and multiple elements in each section.

FIGS. 8A-8C illustrate particular features of an artificial hip: FIG. 8A is a conventional prosthetic hip including acetablular cup and integral ball and stem; FIG. 8B is a custom prosthetic hip with acetablular cup shaped to fit patient contours (as required due to disease, trauma, et al.), with standard integral ball and stem, and stem designed to precisely fit patients intramedullary space, femur contours, and have a specific texture and/or material to improve bone interface; FIG. 8C is a hybrid prosthesis having a conventional prosthetic hip ball and stem but having a customized adjustable length according to the invention (Pin or screw to lock position not shown).

### DETAILED DESCRIPTION OF THE EXEMPLARY EMBODIMENTS

Before the present methods are described, it is understood that this invention is not limited to the particular methodology and protocols described, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a device” includes a plurality of such devices and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference for the purpose of describing and disclosing the devices, fabrication methods, subjects in need, instruments, statistical analysis and methodologies which are reported in the publications which might be used in connection with the invention. Nothing herein is to be construed as an admission that the invention is not entitled to antedate such disclosure by virtue of prior invention.

As used herein, “Subject” means mammals and non-mammals. “Mammals” means any member of the class Mammalia including, but not limited to, humans, non-human primates such as chimpanzees and other apes and monkey species; farm animals such as cattle, horses, sheep, goats, and swine; domestic animals such as rabbits, dogs, and cats; laboratory animals including rodents, such as rats, mice, and guinea pigs; and the like. Examples of non-mammals include, but are not limited to, birds, and the like. The term “subject” does not denote a particular age or sex.

The present invention provides methods, techniques, materials and devices and uses thereof for custom-fitting biocompatible implants, prosthetics and interventional tools for use on medical and veterinary applications. The devices produced according to the invention are created using additive manufacturing techniques based on a computer generated model such that every prosthesis or interventional device is personalized for the user having the appropriate alloy composition for each use.

In one preferred embodiment, the present invention provides a method of custom-fitting a biocompatible device. This method comprises the steps of (a) receiving input imaging data from a patient; (b) calibrating, analyzing and constructing a solid model from the input imaging data; and (c) manufacturing the biocompatible device from the solid model. In this method, the device may be an implant, a prosthesis or an interventional tool.

In this method, preferably, the input imaging data is received from MRI, X-Ray, CT or PET scanning of the patient. Also, the methods of calibrating, analyzing and constructing the solid modeling from input imaging data is performed through computer aided designing, computer aided manufacturing, finite element analysis of biological tissue of the patient, finite element analysis of materials, solid modeling or three-dimension visualization instruments and related methods.

In a preferred embodiment, the biocompatible device is manufactured by additive manufacturing process for producing the near net shape component and state of the art subtractive manufacturing processes for finishing the component. Yet in another embodiment, the device may be a skeletal orthopedic prosthesis or implant, a dental prosthesis or implant or a soft tissue or hard tissue prosthesis or implant.

In another embodiment, the biocompatible device is selected from a group consisting of long bones, plates, intramedullary rods, pins, total joint prosthesis or portions thereof, pelvic reconstruction prosthesis, cranial reconstruction prosthesis, maxillofacial reconstruction prosthesis, dental prosthesis, external fixation device for aligning long bones and the spine, sliding joints, overlapping plates, external or implantable orthopedic intervention prosthesis, adjustable fixtures, internal Ilizarov device for enabling the expansion or lengthening of long bones, implantable non-orthopedic prosthesis for cardiovascular, neurological, digestive or interventional implant device for soft or hard tissue repair, cardiovascular stents, urological stents, interventional tools, interventional guides to assist accurate preparation of the tissue to enable the proper fit of the device, and instruments for laparoscopic, interventional, radiological, and minimally invasive procedures for cardiovascular, neurological, digestive applications in soft or hard tissues.

In a preferred embodiment, the biocompatible device is manufactured from materials such as Cobalt-Chromium-Molybdenum alloy, Titanium alloy, commercially pure Ti (cpTi), medical grade stainless steel, Tantalum, Tantalum alloy, Nitinol, ceramics, oxides, minerals, glasses and combinations thereof. Preferably, these materials are selected based on desirability of biomechanical properties and interaction with surrounding biological environment of the device.

In another preferred embodiment, the device is manufactured using at least two materials which are fabricated sequentially, regionally, locally or combinations thereof. As used herein, regionally indicates a large area of the prosthesis whereas locally indicates a smaller region which is limited only be the resolution of the deposition process. In such instances different localized regions can have two or more materials is specific desired regions or location or large regions.

When at least two materials are used, the gradient of certain dissimilar materials may effect undesirable galvanic processes that can lead to corrosion or release of undesirable ions, thus such combinations are necessarily avoided.

In another preferred embodiment, the device is a bone prosthesis and the fabrication materials are Ti6 in combination with cpTi. More preferably, the fabrication material is Nitinol (NiTi) alloy, such that the device surface is substantially made of Ti for minimizing Ni toxicity.

In certain embodiments, the biocompatible device is fabricated by additive manufacturing fabrication. Such methods are known in the art. For example, the field of additive manufacturing is the automatic construction of physical objects using solid freeform fabrication. Solid freeform fabrication (SFF) or additive manufacturing is a technique for manufacturing solid objects by the sequential delivery of energy and material to specified points in space to produce the solid. While the techniques of SFF share some similarity with techniques of rapid prototyping, rapid prototyping produces only a prototype typically made of plastic polymer which then requires manufacture using indirect and conventional manufacturing processes. However, modern techniques of SFF allow for the integration of more powerful methods of computer imaging and manufacturing techniques. For example, such techniques include, but are not limited to, laser engineered net shaping (LENS), which uses a laser to melt metal powder and deposit it on the part directly, this has the advantage that the part is fully solid and the metal alloy composition can be dynamically changed over the volume of the part; selective laser sintering (SLS), in which a laser is used to fuse powdered nylon, elastomer or metal, in this process a heat treating process called bronzed infiltration is necessary to produce fully dense metal parts, these parts, though fully dense do not possess the material characteristics of a production component therefore functional prototypes are the only application for the SLS approach; electron-beam projection lithography (EPL), which is similar to LENS and allows the part to be fabricated using a powdered metal alloy along the leading edge which is sintered using an electron beam instead of a laser; electron beam melting (EBM), in which electrons are emitted and projected at a powdered metal bed in which the molten metal is added layer by layer until the part is completed; and direct metal deposition (DMD), DMD is similar to LENS in that the desired alloy is added, in powdered form, directly to the substrate or biocompatible device and melted by a laser beam such that the device is built up layer by layer in the size, shape and particular alloy content desired. DMD, EPL, LENS and EBM afford the advantage that the composition, shape and texture of the product can be changed as the part is being fabricated. During additive manufacturing fabrication, the process may be stopped such that an element may be added or the alloy composition changed. Then the process may be followed by continued additive manufacturing. Further, it should be appreciated that using the disclosed methods, the biocompatible device can be used such that the manufacturing materials are deposited regionally (e.g. an entire area of the implant) or locally (e.g. small areas that may be as small as the resolution of the instrumentation will allow) in some cases such area will be on the order of a few microns to tens of microns depending on the additive manufacturing process used.

During this fabrication, the device is further added with an element. Such elements may include a functional sensor, an optical element or a structural element. In another embodiment, such elements include a microelectromechanical system (MEMS) lens, optical lens, ceramic whisker or a curved external fixture for Ilizarov device or any other element that is not damaged by thermal, optical and other constraints posed by the additive manufacturing process, and its resolution limits.

In certain preferred embodiments, the biocompatible device has internal structure or surface which may include honeycomb, strut or ribbed features, or combinations thereof.

In certain other preferred embodiments, the biocompatible device may be a supporting fixture for neck or spine trauma. In certain embodiments, the method of custom-fitting a biocompatible device may be a custom cast or an articulation brace device having adjustability such that the range of articulation can be slowly expanded. In other embodiments, the biocompatible device is a surgical tool that fits to hand and motion mechanics.

In a most preferred embodiment, the invention provides a method of custom-fitting a biocompatible device, comprising the steps of: (a) quantitatively calibrating a medical image; (b) analyzing the calibrated medical image; (c) compiling computer aided design (CAD) of the analyzed and calibrated medical image; (d) creating computer aided manufacturing (CAM) for CAD of step (c); (e) performing finite element analysis of biological tissues of CAM from step (d); (f) performing finite element analysis of materials; (g) performing solid modeling using 3-D visualization instrumentation and virtual reality; and (h) manufacturing the device using additive manufacturing processes. In this embodiment, the additive manufacturing process used is preferably DMD, EPL, LENS, EBM, SLS or combinations as needed. Certain other embodiments are devices produced by processes described above.

Generally, the present invention comprises methods and tools to produce implantable devices that will precisely fit individual patients. This invention is implemented through a combination of technologies including medical imaging (including CT, NMR, X-ray, ultrasound, laser interferometry and others), quantitative image analysis, computer aided design, computer aided manufacturing, finite element analysis of biological tissues, finite element analysis of materials, solid modeling, 3-D visualization instrumentation and methods (virtual reality), and additive manufacturing process that can directly produce high strength implants from biocompatible materials with much greater structural and geometric design flexibility than conventional forging and “subtractive” machining methods. This invention also comprises methods and devices for other medical devices including implants that do not require precise custom fitting to patient data but nonetheless utilize the methods and tools described herein, methods to produce surgical tools and devices that are not implanted, and other related technologies that will be apparent to those skilled in the medical and material fabrication arts.

Typically in a preferred exemplary embodiment, a customized implant is generated as described below:

First, a 3D image data of the patient is obtained with dimensionally calibrated medical imaging instrumentation such as MRI and CT, and presented for clinical evaluation. Presentation can be provided via virtual 3D display, multiple 2D sections, a solid 3D model, or a combination of these and other modalities.

Second, clinical evaluation is made to determine the desired morphology of areas to be surgically manipulated (e.g. areas of interest, ROI) such as re-aligned or resectioned, and an initial determination is made of how an implant will be shaped to make the necessary reconstruction. Additional clinical data may also be used in this determination, as appropriate based on the best possible medical practice.

Third, the desired shape of the implant is evaluated with respect to the intended surgical procedure based upon multiple factors. These include biomechanical FEA of tissue and FEA of implant material, mechanism for short-term and long-term tissue bonding and attachment, desired surgical procedure, material choices, structural integrity, and the incorporation of any pre-engineered standard elements in the implant. Standard elements may include articulation components (such as the ball and socket of a prosthetic hip joint), joinery to enable multiple sections of an implant to be assembled and attached during the surgical procedure, and design features to enable the device to be adjusted in size or shape during the initial implantation and at a future time post implantation, if desired.

Fourth, the above designed implant is then evaluated by a clinician using dimensionally calibrated virtual 3-D presentation methods and/or solid models. Fit is checked, methods of attachment to healthy tissues are evaluated, methods of assembly of implant components (if multiple components) are evaluated, and the entire surgical procedure is performed “virtually” using 3-D display and related methods and/or with solid models. If required, these steps are repeated until a final digital design and surgical plan are made.

Fifth, the final design of the implant is created digitally (computer aided design or CAD) to precisely match the factors determined above. This includes the overall shape, choice of material or materials, thickness and thickness gradients at all locations, design of internal structures such as honeycombs, struts and voids to provide ideal structural rigidity, placement of pre-engineered standard elements, surface materials (if different from bulk), surface texture, and any other necessary features. The spatial resolution of the design is ˜10 μm to correspond with the manufacturing resolution and material handling capabilities of the direct manufacturing tooling and processes (but may be higher resolution as technology advances).

Sixth, the design created above is fabricated using direct computer aided manufacturing (CAM) digital methods such as additive manufacture fabrication to produce the implant with laser-based additive free-form manufacturing and related methods. Fabrication of each component is performed with the desired material or materials directly from powdered metals (and certain other materials) that are delivered to the desired spatial location and then laser annealed in place. This produces a very high strength fine-grain structure, enables the fabrication of internal features, enables layers of multiple materials, gradients of material properties, inclusion of ancillary internal elements, and produces resultant structures that generally require minimal post-fabrication processing.

Seventh, any necessary post fabrication processes are performed on the implant. Grinding and polishing may be required for joining surfaces and for bearing surfaces, such as in articulation joints. Additional processing such as ion beam implantation or annealing may be performed, as required. The surface texture resolution of the laser-based additive free-form manufacturing process is 10 μm with no rough or abrupt transitions. It is thus intrinsically suitable for many tissue interfaces without further processing.

Eight, the device is then cleaned, sterilized, packed, labeled, and shipped to the clinic for the actual surgical application as was designed for using the virtual simulation.

The present invention can be applied to improve implantable and other medical devices including the following:

Implantable Orthopedic Devices: Custom implantable devices may be created for a wide variety of clinical implants including skeletal orthopedic appliances for repair of long bones (including plates, intramedullary rods, pins, and total joint prosthetics or portions thereof), pelvic reconstruction appliances, appliances for repair of cranial defects or damage, maxillofacial repairs, dental prosthetics, and others that will be apparent to those skilled in the art.

Prosthetic Devices: The methods described above may also be used for the design and development of custom devices for external fixation, such as used for aligning long bones and the spine, and for generic or non-custom devices intended for external or implanted orthopedic intervention, and others that will be apparent to those skilled in the art.

Soft Tissue Implant Devices: The methods described above may also be used for the design and development of custom and generic devices for implanted non-orthopedic applications such as for cardiovascular, neurological, gastrointestinal or other interventional implants used for soft or hard tissue repair.

Cardiovascular and Urological Stents: The methods described above may also be used for the design and development of superior and advanced devices such as geometrically complex cardiovascular and urological stents due to the unique capabilities of the design and fabrication capabilities of this invention, and for other applications that will be apparent to those skilled in the art.

Interventional Tools: The methods described above may also be used for the design and development of interventional tools and instruments such as required for laparoscopic, interventional radiological, and minimally invasive procedures for cardiovascular, neurological, digestive or other applications in soft or hard tissue, and for other applications that will be apparent to those skilled in the art.

Surgical Instruments: The methods described above may also be used for the design and development surgical instruments having the ergonomic and mechanical properties desired by the surgeon or other end-user to create medical and other tools that will be more comfortable, better weighted and have superior manipulating or cutting surfaces thereby providing superior performance.

The following examples are related to devices and methods of the present invention and are put forth for illustrative purposes only. These examples are not intended to limit the scope of the invention.

### EXAMPLES

### Preferred Exemplary Embodiments

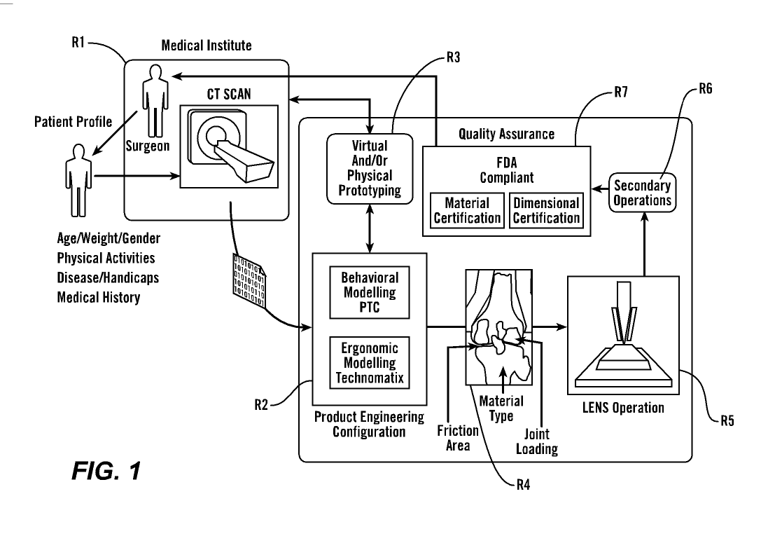

As shown in FIG. 1, in a preferred embodiment, the present invention provides methods and tools to produce implantable medical devices that will precisely fit individual patients. The present invention also comprises medical appliances and tools and implements designed and created through the disclosed process. Generally, the invention is implemented through a combination of technologies including medical imaging (including CT, NMR, X-ray, ultrasound, laser interferometry and others) and patient consultation R1. Next, the product engineering configuration R2 analysis is implemented using both behavioral modeling (WHAT IS PTC?) and ergonomic modeling technomatix analysis. Next, virtual and/or physical prototyping is performed R3 which allows for validation of the product engineering results by further reference with R1. Then, in R4, analysis of the implant site identifies the friction area, analyzes the joint loading and identifies material types that can or should be used in fabrication. Next, in R5, additive manufacturing is performed using, in one preferred embodiment laser engineered net shaping. However, other methods of additive manufacturing fabrication can be used. Then, in R6 secondary, finishing, operations are performed such as cleaning and sterilizing is performed. Then, in R7 quality assurance such as, FDA compliance, material certification and dimensional certification is performed. Then, data determined in R7 is returned to the clinician confirming quality and suitability of the device and the device is implanted. As shown, quantitative image analysis, computer aided design, computer aided manufacturing, finite element analysis of biological tissues, finite element analysis of materials, solid modeling, 3-D visualization instrumentation and methods (virtual reality), and additive manufacturing process can directly produce high strength implants from biocompatible materials with much greater structural and geometric design flexibility than conventional forging and “subtractive” machining methods in which a larger piece of material is carved away or machined down to arrive at the product. This invention also comprises methods and devices for other medical devices including implants that do not require precise custom fitting to patient data but nonetheless utilize the methods and tools described herein, methods to produce surgical tools and devices that are not implanted, and other related technologies that will be apparent to those skilled in the medical and material fabrication arts.

### Example I

### Image Acquisition and Analysis

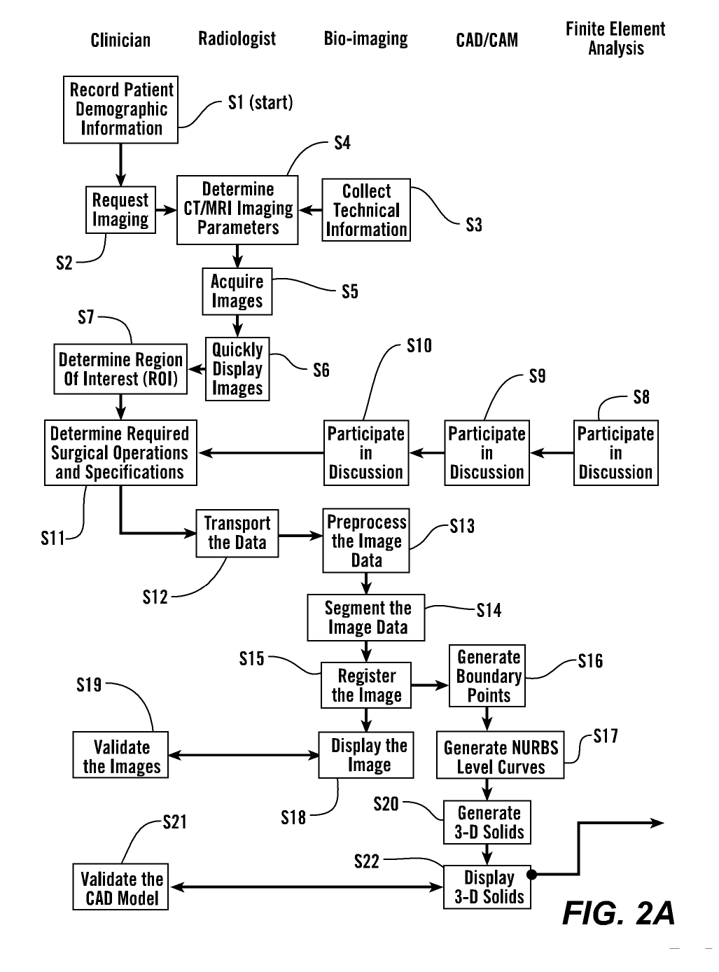

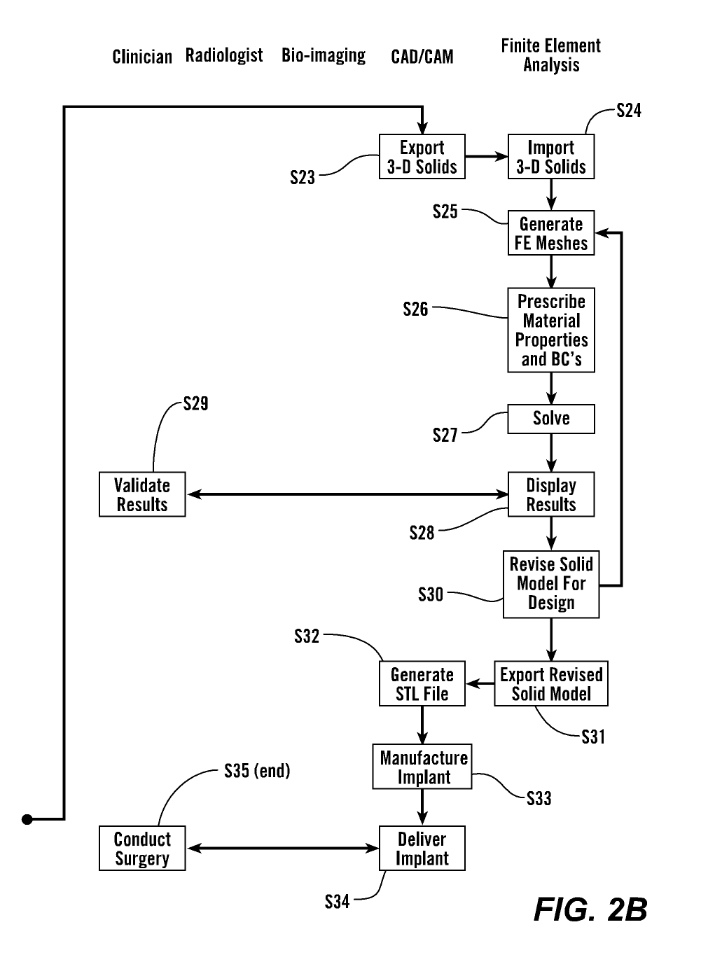

As shown in FIGS. 2A and 2B, in some embodiments, the process starts with step S1 where the patient's demographic information is recorded and the clinician makes a request for imaging, S2. 3-Dimensional image data is obtained from the patient S4 and presented for clinical evaluation with the cooperation of multiple specialists, S3 and using the invention described herein (FIGS. 1 and 2A). This uses multiple steps as listed in Table 1, and further elaborated below.

TABLE 1
Image Acquisition and Analysis

| | |
|---|---|
| 1 | CT/MRI Image calibration |
| 2 | Calibration of laser surface contour scanning to determine surface |
| | structure as required for certain applications |
| 3 | Physical correlation of pixel data for precise reconstruction of the |
| | patient's anatomical structure |
| 4 | In situ validation |
| 5 | Establish protocol for image acquisition and transport |
| 6 | Troubleshooting of various imaging parameters - size, intensity, |
| | orientation, spacing, etc. |
| 7 | Image file format, size, and transport medium |
| 8 | Image/patient database |
| 9 | Integrate with CAOS (computer assisted orthopedic surgery) system, |
| | as appropriate |
| 10 | Perform Image reconstruction |
| 11 | NURBS interpolation of boundary points |
| 12 | Contour based reconstruction for semi-parametric CAD modeling |
| 13 | Point-cloud reconstruction for explicit CAD modeling |
| 14 | Morphing for implant fitting/sizing/design revision |
| 15 | 3D surface and solid modeling of internal features |
| 16 | Export to IGES/STL format for FEA and CAM |
| 17 | Cross-calibration across imaging/CAD/CAM systems |
| 18 | Data acquisition and reduction |

Image Calibration: A multimodality deformable phantom is constructed to calibrate and validate the imaging system's ability to precisely capture the physical dimension of a 3D object in various view areas. The phantom consists of sets of 3D markers with known physical dimension and locations. The fiducial markers (Region of Interest, ROI, S7) are identified on the image yielding their pixel coordinates which are used to calculate the marker distances and polygonal areas in comparison with the physical measurements obtained from a 3D laser surface scanner and digital calipers. Image calibration coefficients will be estimated using a least square algorithm. Furthermore, after 3D reconstruction of the phantom model from the images, axial calibration is conducted for calibrating the marker axial distance and volume in comparison with the physical measurements obtained from a 3D laser surface scanner and digital calipers. Imaging parameters are also calibrated to attain the minimum resolution of the imaging system. For accurate replication of the patient-specific anatomy further onsite calibration will be done by simultaneously imaging a smaller scale phantom while the patient images are acquired, S5. After the region of interest is identified, then the patient and other clinical personnel participate in discussion of the available therapeutic technique/intervention necessary (S8-S10). This is followed by a determination of the required surgical operations and specifications, S11. The data is then transferred to the radiologists and bio-imaging personnel, S12/S13.

Surface Reconstruction: A series of the calibrated images are then segmented (S14) and registered (S15). An image is segmented first by dividing it into different regions of homogeneous properties. Each anatomic component (class) is classified into separating surfaces as defined by discriminant functions. After a finite number of unstructured boundary points are computed (S16) in a slice through the segmentation process, curve fitting using cubic splines or non-uniform rational B-splines (NURBS) S17, is done with the boundary points to generate boundary curves (S17) of each anatomic component for further geometric reconstruction. Subsequently, for surface modeling and 3-D geometric reconstruction lofting operation is done with a series of the refitted boundary curves (BCs), S20. In addition once the image is displayed the image is validated, S19, using collaboration software. Following the display of the 3-D solid models, S20, the model is validated by the clinician, S21 and the displayed 3-D solid model is exported to the engineering personnel for final design of the device which includes finite element analysis and human motion simulation S23.

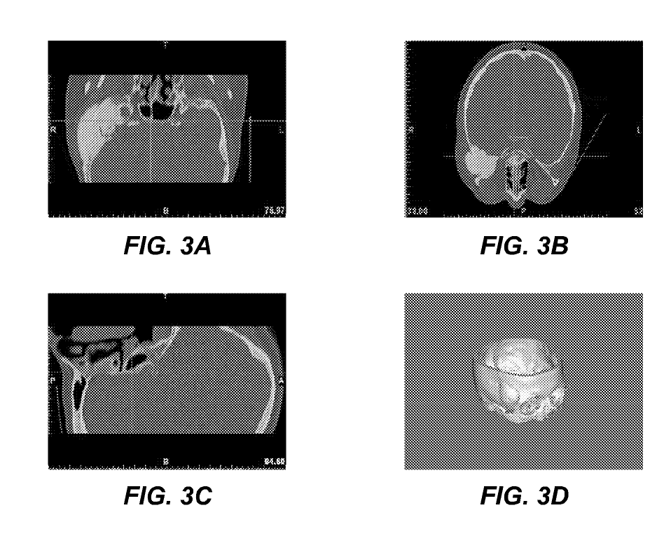

Clinical Evaluation: Clinical evaluation is made to determine the desired morphology of areas to be resectioned and an initial determination is made of how an implant will be shaped to make the necessary repair. Additional clinical data may also be used in this determination, as appropriate based on the best possible medical practice. Additional clinical information includes patient history for relevant parameters including a complete medical history with emphasis on factors that alter strength of tissues such as general health, anthropometric measures such as height and weight, activity, skeletal and connective tissue health factor including bone density, and others that are critical for application. (FIGS. 2, 3A-3D).

The transfer of information to and from surgeon (S21-S23) is ideally performed with a virtual 3D digital model of patient data that is calibrated for image spatial/spectral resolution and processed to accurately replicate the physical dimensions of the patient-specific anatomical structures. This dataset is transmitted electronically to the clinician who is able to manipulate the digital model dynamically in order to view any necessary aspect of the structure. Using collaboration software such as for example, Microsoft® Live Meeting (Microsoft, Redmond, Wash.) the surgeon then marks the area for any necessary clinical manipulation such as excision, and labels additional areas such as desirable locations for attachment of the prosthetic, regions that must be left alone, and provides other annotations regarding the surgical procedure and factors that should be addressed in the design of the final implant. This data is then communicated, digitally in preferred embodiments, back to the manufacturing firm, S24, where further evaluation and design is performed. In cases where surgeons are not comfortable with virtual 3D digital model, or where such computational and visualization hardware is not available, the surgeon can receive a dimensionally calibrated physical replica of the 3D digital model (S20-22) of a polymer or other material that is then manually marked by the surgeon (S21).

Implant Design Based on Clinical Evaluation: The desired shape of the implant is evaluated with respect to the intended surgical procedure based upon multiple factors. These include biomechanical Finite Element Analysis (FEA) of tissue and FEA of implant material, S25, mechanisms for short-term and long-term tissue bonding and attachment, desired surgical procedure, material choices, and the incorporation of any pre-engineered standard elements in the implant, S26. Finite Element Analysis is well known in the art and is a computer simulation technique in which the object is represented by a geometrically similar model consisting of multiple, linked, simplified representations of discrete regions or finite elements on an unstructured grid. See, for example, Finite Element Methods for Structures With Large Stochastic Variations, Elishakoff, I. and Ren, Y., 2003; Finite Element Methods With B-Splines, Hollig, K., 2003. Standard elements may include articulation components (such as the ball and socket of a prosthetic hip joint), joinery to enable multiple sections of an implant to be assembled and attached during the surgical procedure, and design features to enable the device to be adjusted in size or shape during the initial implantation and at a future time post implantation, if desired. FEA provides a mathematical method to solve the limitations of the implant based on the geometric design and material type used, S27.

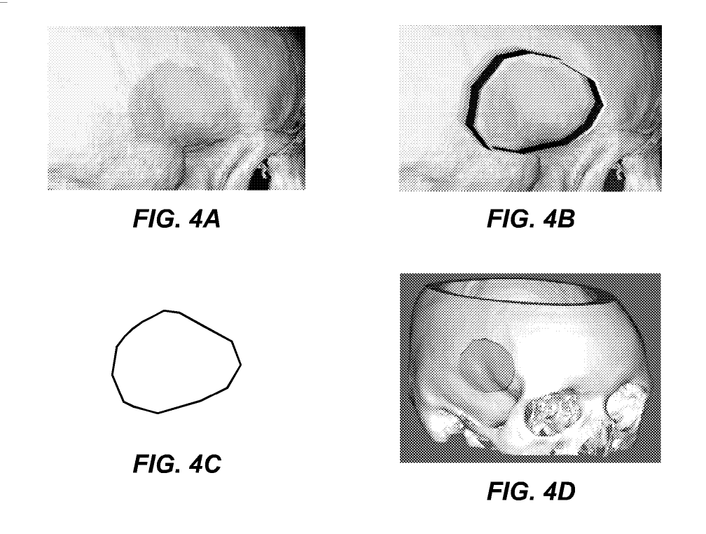

The general fit of the device is designed based on the shape of the tissue it will interact with, as primarily determined from the CT, NMR and related calibrated medical imaging data. In addition, for some tissues such as maxillary, facial and skull reconstruction where external appearance is critical, quantitative external imaging and shape scanning are used to obtain good esthetics using 3-D laser surface scanners (FIG. 4), S27.

Materials used in the device are chosen for biocompatibility such as metal alloys commonly used in medical devices including CoCrMo, Titanium alloys and commercially pure IT (cpTi), medical grade stainless steels, tantalum and tantalum alloys, and others including included ceramics and oxides that can be incorporated into the design. The regions that will adhere to bone, when desirable, may be formed of cpTi to enhance bone attachment, and/or incorporate specific 3-D textures, modulus, other materials (such as oxides, minerals, glasses) or incorporate other properties to promote bone attachment and ingrowth that are known in the art.

Material and device-bone material interface can be different in different locations, such as to provide different interfaces with cortical and cancellous bone to alter attachment and local biomechanical interaction. Finite element analysis mechanical simulations of tissues and the implant (S24-S30) are used to optimize the interaction to provide best possible function and minimize stress shielding. In addition to variations of the prosthetic material and the material thickness, internal material structures such as honeycombs, struts or ribs may be designed in to tailor the local and the global biomechanics of the device. Table 2 outlines the methodology for FEA stimulation.

TABLE 2

| | |
|---|---|
| 1 | FE model generation |
| 2 | Pre and post-operative conditions |
| 3 | Optimum selection of element type and size |
| 4 | Mesh optimization for convergence |
| 5 | Material properties |
| 6 | Image based assessment |
| 7 | Noninvasive onsite testing |
| 8 | Solution |
| 9 | Linear vs. nonlinear |
| 10 | Functional assessment and validation |

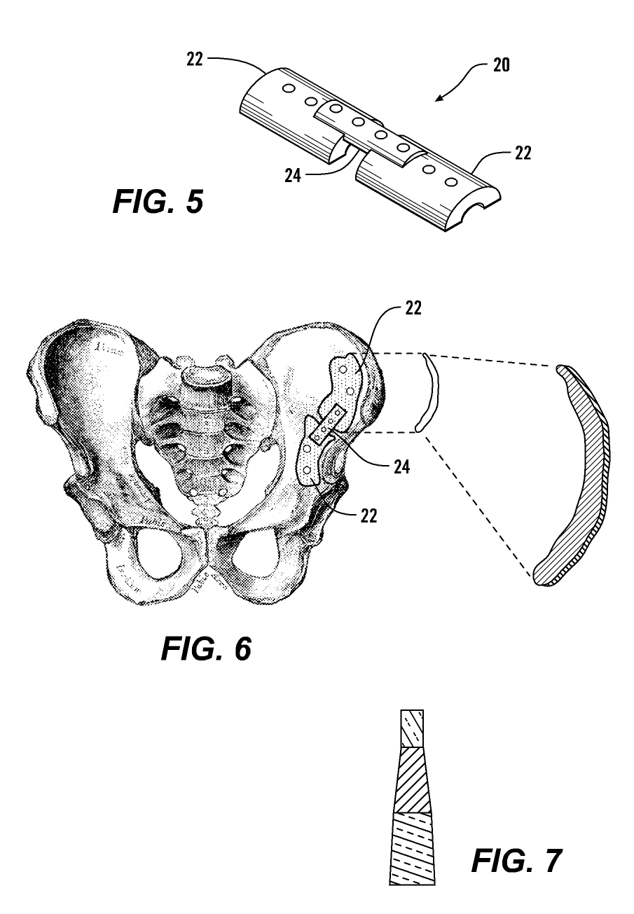

As required for an application, the implant may be designed in multiple components. For example, it will be clinically desirable to bridge or surround ligament attachments that are otherwise healthy for reconstruction of a diseased or traumatized pelvis. Separate, attachable, components of the implant are then designed to surround such structures, and the components are then assembled and attached as necessary in surgery. FIG. 5 represents an implant 20 having opposing anchor ends 22 that are adjustably connected using a sliding bridge 24. In use, such an implant may be used to reconstruct the traumatized pelvis FIG. 6. In this embodiment, the two anchor ends are fabricated according to the data obtained using MRI and CAT images as discussed above and shown in FIG. 3A-D. The anchor ends 22 are put in place, spanning the damaged area and the bridge 24 holds the anchors ends 22 together. Further, it should be appreciated that using the methods described herein, the anchor ends (or any other part of the device) may be constructed with variable thickness and shape to best fit the pelvic tissue and provide the appropriate biomechanical properties.

The design of the implant will allow onsite adjustments, where feasible and desirable, since even the best solid model will not always be a perfect representation of the tissue exposed during surgery. This will enable the surgeon to make necessary adjustments during the procedure. In part this may be due to the imperfect tools and especially relatively coarse method of hand-held burrs and other tools used to remove bone during surgery. As required, specific tools and guides can also be designed and fabricated to assist tissue preparation.

The ideal method to attach an orthopedic prosthesis will be determined through anatomic and biomechanical evaluation of the healthy bone. Analysis will determine the best locations, best orientation angles with respect to loading, and related biomechanical analyses. Conventional bone-screw technology may be used by the surgeon to make this attachment. Multiple locations for bone-screws will enable the surgeon to determine the optimum choices during the procedure to ensure attachment to high strength bone. As needed, a biomechanical analysis of alternate screw locations may be provided to the surgeon. Flanges and wings may be used to support less strong areas with thin cortical bones and/or remarkable trabecular bones, while flanges on both sides of a structure with a thru connection can provide solid anchoring when required. Fitting the device in place may be accomplished with plates that bridge prosthesis with remaining tissue. Such plates can be provided in several sizes when adjustability may not be possible or provide sufficient range.

As required for a specific application, the prosthetic may be designed with intrinsic adjustability to alter the fit during surgery using features such as sliding joints (e.g. sliding dovetails) or overlapping plates (FIGS. 5 and 6), S28. Such features may also be used to alter fit post surgery if required due to growth or other factors or needs. Such an adjustable fixture includes an internal Ilizarov device to enable the expansion or lengthening of long bones. Access to the adjusting structure is designed so that such alterations are made with minimal surgical trauma, such as minimally invasively.

Evaluation of Designed Implant by Clinician: The implant so designed is evaluated by the clinician, S29, using virtual 3-D presentation methods and/or solid models as illustrated in FIGS. 3A-3D and 4A-4D. Fit is checked, methods of attachment to healthy tissues are evaluated, methods of assembly of implant components (if multiple components) are evaluated, and the entire surgical procedure is performed “virtually” using 3-D display and related methods and/or with solid models. If required, steps 3 and 4 shown in TABLE 2 and steps S25-S29 (FIG. 2B) are repeated until a final digital design and surgical plan are made, S30.

The final design of the implant is created digitally using CAD solid modeling to precisely match the factors determined above, S31. This includes the overall shape, choice of material or materials, thickness and thickness gradients at all locations, design of internal structures such as honeycombs to provide ideal modulus, placement of pre-engineered standard elements, surface materials (if different from bulk), surface texture, and any other necessary features. The spatial resolution of the design is ˜10 um to correspond with the manufacturing resolution and material handling capabilities of the direct manufacturing tooling and processes.

Pre- and post-operative clinical and biomechanical assessments will be made for functional assessment of the custom implants. Clinical evaluations include joint range of motion and strength testing. For biomechanical assessment finite element analysis simulations will be used to develop models with the implant in-situ. Various loading conditions will be tested to predict stress localization in the interface and stress shielding. Model parameters will be obtained from the image data and material testing of biopsy specimens harvested during surgery, S30.

Pre- and post-operative clinical and biomechanical assessments will be made for functional assessment of the custom implants. Clinical evaluations include joint range of motion and strength testing. For biomechanical assessment finite element analysis simulations will be used to develop geometric CAD solid models with the implant in-situ through virtual surgical operation simulating the actual surgery done to the patient. A number of 10 noded 3D tetrahedral elements are used to create finite element meshes of the geometric models. Mesh convergence analysis is conducted for accurate simulations. Various loading conditions as obtained from the literature and pre- and post-operative functional testing of the patient will be tested to predict stress localization in the interface and stress shielding. Model parameters will be obtained from the image data and material testing of biopsy specimens harvested during surgery. A linear static analysis will be conducted to obtain first-order solutions. As needed, more sophisticated analysis such as nonlinear and transient analyses will be conducted to reflect the level of physical activities of the patient. The simulation results are cross-validated with those from the pre- and post-operative functional testing and further biomechanical assessments are done accordingly.

### Example II

### Manufacturing

The design created above is fabricated using direct computer aided manufacturing (CAM) digital methods to produce the implant with laser-based additive free-form manufacturing as described above, S33. Fabrication of each component is performed with the desired material or materials directly from powdered metals (and certain other materials) that are delivered to the desired spatial location and then laser annealed in place (using, for example, DMD, LENS or the like) or annealed using an electron beam (EBM). This produces a very high strength fine-grain structure, enables the fabrication of internal features, enables layers of multiple materials, gradients of material properties, inclusion of ancillary internal elements, and produces resultant structures that generally require minimal post-fabrication processing.

Multiple materials are applied sequentially, locally, and in specific locations, if required to achieve desired properties For example, the bone interface aspect of a bulk Ti6 implant can be fabricated with cpTi to enhance bone bonding, or a gradient of materials may be created to effect galvanic processes.

In one embodiment, Nitinol (NiTi) shape-memory alloy structures can be entirely Ti on the surface to minimize Ni toxicity.

As desired during the additive manufacturing approach, the process may be stopped and an element may be added, followed by continued additive manufacturing. Such elements can include functional sensors such as MEMS devices including, but not limited to, neuronal, neuromuscular or skeletal stimulators, optical elements such as lens, structural elements such as ceramic whiskers, or other elements to provide functional or other capabilities. Any material or device can be incorporated that is not damaged by the thermal, optical and other constraints posed by the laser or electron additive manufacturing process, and in consideration of the laser or electron additive manufacturing process resolution limits.

### Example III

### Post Fabrication

Any necessary post fabrication processes are performed on the implant. This includes subtractive manufacturing processes for finish machining operations, grinding and polishing as may be required for joining surfaces and for bearing surfaces, such as in articulation joints. Additional processing such as ion beam implantation or annealing may also be performed may be performed, as required. The surface texture resolution of the additive manufacturing process is currently ˜10 μm with no rough or abrupt transitions. It is thus intrinsically suitable for many tissue interfaces without further processing. For example, this texture limit can enable the direct fabrication of tissue interfaces with features that may be as small as 10 μm, or larger features as desired in order to enhance tissue interactions such as bone growth into the implant.

Other post fabrication processes include ion beam implantation, as is routinely used to harden bearing surfaces in prosthetic knees and hips, as well as annealing and other thermal treatments to effect material structure.

Preparation for Transport and Clinical Use

The device is then cleaned, sterilized, packed, labeled, and shipped as necessary for the actual surgical application, S34/S35 where the process ends.

### Example IV

### Applications of Technology

Using the methods and technology described above, custom implantable devices may be created for a wide variety of clinical implants including skeletal orthopedic appliances for repair of long bones (including plates, intramedullary rods and total joint prosthetics or portions thereof), pelvic reconstruction appliances, appliances for repair of cranial defects or damage, maxillofacial repairs, dental prosthetics, and others that will be apparent to those skilled in the art.

A unique feature of this invention is designed-in intrinsic adjustability to alter the fit during surgery using features such as sliding joints (e.g. sliding external or internal dovetails) or overlapping plates (FIGS. 5-8). Such features may also be used to alter fit post surgically if required due to growth or for therapeutic reasons such as with an internal Alizarin device. Access to the adjusting structure can be planned so that such alterations can be made with minimal surgical trauma, such as minimally invasively or even without invasion using an implanted actuator controlled remotely by an external signal (such as radio frequency control), or directly by percutaneous transmission (such as via momentarily or long term inserted control lines).

The methods described above may also be used for the design and development of custom devices for external fixation, such as used for aligning long bones and the spine, and for generic or non-custom devices intended for external or implanted orthopedic intervention, and others that will be apparent to those skilled in the art.

The unique capabilities of the design and manufacturing process enable multiple elements to be incorporated in monolithic structures, internal features of virtually any desired geometry, and the creation of shapes that are not readily created with other methods such as complex curves and sliding joints.

An application of a complex device is a curved external fixture for an Ilizarov device. Other applications include supporting fixtures for neck or spine trauma that accurately fit the patient, and custom casts and articulation brace devices with adjustability so that range of mobility can be slowly introduced as required for physical therapy.

The methods described above may also be used for the design and development of custom and generic devices for implanted non-orthopedic applications such as for cardiovascular, neurological, digestive or other interventional implants used for soft or hard tissue repair. The method allows superior devices to be made, such as, for example, geometrically complex stents (FIG. 7) due to the unique capabilities of the design and fabrication invention described above, including, but not limited to produce devices having varying alloy content, the ability to include honeycombs-shaped internal structures, hollow internal structures, full or partial rib internal structures, struts, wings and other complex features not possible using convention machining technology, such as for example, functional elements such as sensors, actuators, stimulators and the like, and for other applications that will be apparent to those skilled in the art.

The unique capabilities of the design and manufacturing process enable multiple elements to be incorporated in monolithic structures, internal features of virtually any desired geometry, and the creation of shapes that are not readily created with other methods. Examples include stents of any shape, with spatially variable material flexibility, and expandability. Other examples include staples, clips, pins and other devices to effect tissue closure or positioning, cases for devices such as pacemakers and other encapsulated electronics, sensors, and actuators, dimensionally complex multiple material (as required) detection and stimulation electrodes, neuro-stimulators and sensors, and valve prosthetics, and components such as stents (frames) used in tissue valves.

The methods described above may also be used for the design and development of interventional tools and instruments such as required for laparoscopic, interventional radiological and minimally invasive procedures for cardiovascular, neurological, digestive or other applications in soft or hard tissue. Using this invention, superior devices may be made such as geometrically complex cardiovascular, urological and biliary stents (FIG. 7) due to the unique capabilities of the design and fabrication capabilities of this invention. Moreover, the design capabilities for fitting structure and biomechanics to achieve optimal devices can also be applied to the physician using these devices in order to create medical and other tools that will be more comfortable and thus provide superior performance by anatomic and biomechanical fitting of the device to the user and to the necessary motion used for the procedure.

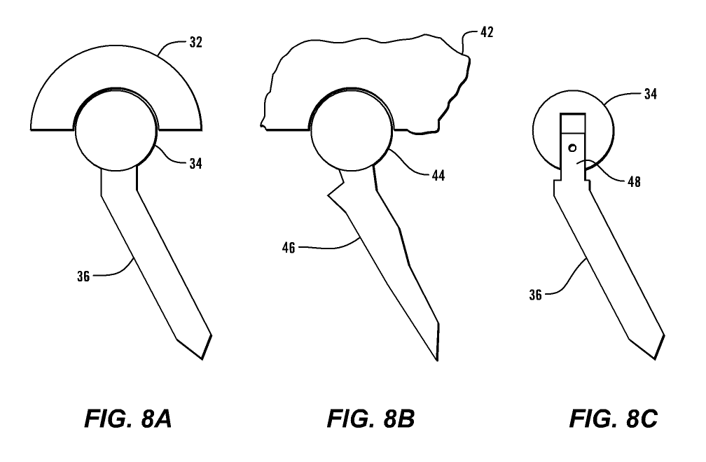

Similarly, the invention can be used to create hybrid prosthetic devices such as, for example, artificial hips. In this embodiment, illustrated in FIGS. 8A-C, the invention can be used to create a prosthesis that is designed to fit into the patients existing skeletal architecture. FIG. 8A illustrates a conventional prosthetic hip including acetablular cup 32 and integral ball 34 and stem 36. FIG. 8B illustrates a custom prosthetic hip with acetablular cup 42 shaped to fit patient contours (as required due to disease, trauma, et al.), with standard integral ball 44 and stem 46, with the stem 46 designed as described and illustrated in FIG. 3 to precisely fit the patient's intramedullary space, femur contours, and have a specific texture and/or material to improve bone interface. FIG. 8C illustrates conventional prosthetic hip ball 34 and stem 36 with adjustable bridge 48 between (otherwise conventional) ball and stem. In this example, the fastening device, such as, a pin or screw to lock position is not shown.

Overall, the unique capabilities of the design and manufacturing process enable multiple elements to be incorporated in monolithic structures, internal features of virtually any desired geometry, and the creation of shapes that are not readily created with other methods. This includes (1) Curved tubes with telescoping elements and multiple lumens; (2) Stents and other devices that do not require laser cutting with consequent production of sharp edges; (3) Shapes that are not readily fabricated with conventional machinery including wall thicknesses, bifurcations, element spacing, inside and outside diameters, and extensibility that vary along length; and (4) Materials that include composites of multiple metals.

Thus, although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

What is claimed is:

1. A method of custom-fitting a biocompatible device, comprising the steps of:
(a) receiving input imaging data from a patient;
(b) calibrating, analyzing and producing a three-dimensional computer aided design solid model from the input imaging data; and
(c) manufacturing the biocompatible device from the digital three-dimensional solid model using additive manufacturing process, wherein the device is selected from a group consisting of an implant, a prosthesis, an interventional tool, or a surgical tool.

2. The method of custom-fitting a biocompatible device of claim 1, wherein input imaging data is received from MRI, X-Ray, CT, ultrasound, LASER interferometry or PET scanning of the patient.

3. The method of custom-fitting a biocompatible device of claim 1, wherein calibrating, analysis and constructing solid modeling from of input imaging data is performed through computer aided designing, computer aided manufacturing, finite element analysis of biological tissue of the patient, finite element analysis of materials, solid modeling or three-dimension visualization instruments and methods.

4. The method of custom-fitting a biocompatible device of claim 1, wherein the biocompatible device is manufactured by additive manufacturing process.

5. The method of custom-fitting a biocompatible device of claim 1, wherein the device is selected from a group consisting of a skeletal orthopedic prosthesis or implant, a dental prosthesis or implant or a soft tissue or hard tissue prosthesis or implant.

6. The method of custom-fitting a biocompatible device of claim 1, wherein the biocompatible device is selected from a group consisting of long bones, plates, intramedullary rods, pins, total joint prosthetics or portions thereof, pelvic reconstruction prosthesis, cranial reconstruction prosthesis, maxillofacial reconstruction prosthesis, dental prosthesis, external fixation device for aligning long bones and the spine, sliding joints, overlapping plates, external or implantable orthopedic intervention prosthesis, adjustable fixtures, internal Ilizarov device for enabling the expansion or lengthening of long bones, implantable non-orthopedic prosthesis for cardiovascular, neurological, digestive or interventional implant device for soft or hard tissue repair, cardiovascular stents, urological stents, interventional tools, interventional guides to assist accurate preparation of the tissue to enable the proper fit of the device, and instruments for laparoscopic, interventional, radiological, and minimally invasive procedures for cardiovascular, neurological, digestive applications in soft or hard tissues.

7. The method of custom-fitting a biocompatible device of claim 1, wherein the biocompatible device is manufactured from materials selected from a group consisting of Cobalt-Chromium-Molybdenum alloy, Titanium alloy, commercially pure Ti (cpTi), medical grade stainless steel, Tantalum, Tantalum alloy, Nitinol, ceramics, oxides, minerals, glasses and combinations thereof.

8. The method of custom-fitting a biocompatible device of claim 7, wherein the material is selected based on desirability of biomechanical properties and interaction with surrounding biological environment of the device.

9. The method of custom-fitting a biocompatible device of claim 1, wherein the device is manufactured using at least two materials which are fabricated sequentially, regionally, locally or in combinations thereof.

10. The method of custom-fitting a biocompatible device of claim 9, wherein the device is a bone prosthesis and the fabrication materials are Ti6 in combination with cpTi.

11. The method of custom-fitting a biocompatible device of claim 9, wherein the fabrication material is Nitinol (NiTi) alloy, wherein further the device surface is substantially Ti for minimizing Ni toxicity.

12. The method of custom-fitting a biocompatible device of claim 1, wherein the device is fabricated by additive manufacturing fabrication, whereby the fabricated device is further fabricated with an element.

13. The method of custom-fitting a biocompatible device of claim 12, wherein the element is a functional sensor, an optical element or a structural element.

14. The method of custom-fitting a biocompatible device of claim 1, wherein the element is a MEMS lens, optical lens, ceramic whisker or a curved external fixture for Ilizarov device.

15. The method of custom-fitting a biocompatible device of claim 1, wherein the biocompatible device has internal structure or surface selected from a group consisting of honeycombs, struts, ribs or combinations thereof.

16. The method of custom-fitting a biocompatible device of claim 1, wherein the biocompatible device is a supporting fixture for neck or spine trauma.

17. The method of custom-fitting a biocompatible device of claim 1, wherein the biocompatible device is a custom cast or an articulation brace device with adjustability where range can be slowly expanded.

18. The method of custom-fitting a biocompatible device of claim 1, wherein the biocompatible device is a surgical tool that fits to hand and motion mechanics.

19. A biocompatible device produced by the process of claim 1.

20. A method of custom-fitting a biocompatible device of, comprising the steps of:
(a) quantitatively calibrating a medical image;
(b) analyzing the calibrated medical image;
(c) compiling computer aided design (CAD) of the analyzed and calibrated medical image;
(d) creating computer aided manufacturing (CAM) for CAD of step (c);
(e) performing finite element analysis of biological tissues of CAM from step (d);
(f) performing finite element analysis of materials;
(g) performing solid modeling using 3D visualization instrumentation and virtual reality; and
(h) manufacturing the device using additive manufacturing processes.

21. A method of custom-fitting a biocompatible device of claim 19, wherein the additive manufacturing process is laser additive manufacturing, laser engineered net shaping, selective laser sintering, electron-beam projection lithography, direct metal deposition or electron beam melting.

22. A biocompatible device produced by the process of claim 20.
